(19) United States
(12) Patent Application Publication
(10) Pub. No.: US 2024/0095795 A1
(43) Pub. Date: Mar. 21, 2024

(54) PROPERTY LEAD FINDER SYSTEMS AND METHODS OF ITS USE

(71) Applicant: DOMAIN HOLDINGS AUSTRALIA LIMITED, Pyrmont Sydney, New South Wales (AU)

(72) Inventors: Pooyan ASGARI, Sydney (AU); Bayan HAMMAMI, Sydney (AU); Yashar MAALI, Sydney (AU); Rogerio ROLDAN, Sydney (AU)

(21) Appl. No.: 18/021,655

(22) PCT Filed: Aug. 9, 2021
(86) PCT No.: PCT/AU2021/050870

§ 371 Date: Feb. 16, 2023

(30) Foreign Application Priority Data
Aug. 12, 2020 (AU) 2020902863

(51) Int. Cl. G06Q 30/0601; G06Q 30/0202; G06Q 50/16

(52) U.S. Cl. CPC G06Q 30/0613; G06Q 30/0202; G06Q 50/16

(57) ABSTRACT

A property lead finder system for determining a property lead, comprising: a transceiving module configured to receive clickstream data from at least one data source, wherein the clickstream data comprising property data, wealth properties history available within the at least one data source and user interaction data based on an interaction of a plurality of users with the at least one data source; a prediction module configured to: map the received clickstream data to a propensity to sell one or more lead properties at a level of a physical property address; determine a propensity data comprising a property address of the one or more lead properties and a score indicating the propensity to sell the one or more lead properties based on the mapping; and match the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property.

### TECHNICAL FIELD

The presently disclosed subject matter generally relates to the field of real-estate. Particularly, the present subject matter relates to a property lead finder system and method for predicting one or more property leads and a future decision of an associated property owner about the sale of an associated property.

### BACKGROUND

In the real estate industry, a property agent's knowledge and expertise is often key to the selling or renting of a property like an apartment, house, or office space. Currently, when a property owner wants to sell or rent their associated property, they usually engage a property agent. The property agent may guide the property owner about various steps of selling or renting a property, and in exchange for these services the property agent may charge a fee or commission. On occasions, the property owner may have a desire to sell/rent their property within a short time-frame, and this may create unnecessary pressure on the property agent to fulfill the client requirements. In the event the property agent is not able to fulfill the client requirements in the defined time, the property agent may not get their fee or commission from the property owner. This may also undermine property owner's expectation and cause the relationship between property owner and their agent to become strained. There is potential for this to lead to the property owner questioning the value of an agent, impacting on the likelihood of said owner engaging that agent for any future needs.

There currently exists a range of real-estate websites that can help property owners sell or rent their properties. The websites generally allow the property owner to upload pictures, and other details about the property and charge a fee for the service. While many of these websites are managed by property management companies (which, in turn, may also employ property agents), the intent of the property website user (buying, selling or renting a property) is unknown until such time as the user enters the website.

It would be attractive, practically and commercially, to have a system that could assist property agents in identifying property owners that might be interested in selling or renting their properties in the future.

It is an object of the present invention to overcome or ameliorate the above discussed disadvantages of the prior art, or at least offer a useful alternative.

### SUMMARY

To overcome the above-mentioned limitations and problems, the present disclosure provides a system for predicting a future decision of a property owner in regards to the sale of an associated property.

An embodiment of the present disclosure provides property lead finder system for determining a property lead including a transceiving module configured to receive clickstream data from at least one data source. The clickstream data comprising property data, wealth properties history available within at least one data source and user interaction data based on an interaction of a plurality of users with the at least one data source. The system also includes a prediction module configured to map the received clickstream data to a propensity to sell one or more lead properties at a level of a physical property address. The prediction module is further configured to determine a propensity data comprising a property address of the one or more lead properties and a score indicating the propensity to sell the one or more lead properties based on the mapping. Further, the prediction module is configured to match the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property.

According to an aspect of the present disclosure, the at least one data source comprises a real-estate website, and an online data analytics server comprising information associated with the real-estate website. In some embodiments, the property data may include an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties. Further, in some embodiments, the propensity data comprises only properties with high propensity to sell.

According to another aspect of the present disclosure, the prediction module is further configured to prevent a lead property having a high propensity to be assigned to an output list of property addresses of more than one third-party to reduce chance of less-welcomed cold calls/contacts by the agents to vendors. The prediction module may apply business logics of the product reflecting the relationship among real-estate website, property agencies, property agents, and potential vendors. For instance, by matching the flagged properties against agencies' client-directory, the prediction module may analyze the strength of relationship of the agents with each of their contacts to ultimately provide every one of flagged properties to its best-possible property agency or property agents in the area. In some embodiments, this process may use the established trust to shorten the nurturing timespan for property agencies/agents and also reduce the less-welcomed cold calls and contacts to the vendors.

In some embodiments, the property lead finder system may include a data sharing module configured to connect with a third-party device associated with the at least one third-party to send the output list of property addresses. Further, the property lead finder system may include a feedback module configured to collect a feedback about a quality of the output list of property addresses from the at least one third-party device. Furthermore, the property lead finder system may include a learning module configured to improve a performance of the property lead finder system based on the feedback.

Another embodiment of the present disclosure provides a method for determining a lead property by using a property lead finder system. The method includes receiving, by a transceiving module, clickstream data from at least one data source. The clickstream data may include property data, wealth properties history available within the at least one data source and user interaction data based on an interaction of a plurality of users with the at least one data source. The method further includes mapping, by a prediction module, the received clickstream data to a propensity to sell one or more lead properties at a level of a physical property address. The method also includes determining, by the prediction module, a propensity data comprising a property address of the one or more lead properties and a score indicating the propensity to sell the one or more lead properties based on the mapping. The method also includes matching, by the prediction module, the propensity data against a third-party database to determine at least one lea property for creating an output list of property addresses for at least one third-party, wherein the output list of property addresses comprises property information of at least one lead property that is common in the one or more lead properties and the third-party's database and a flag indicating the propensity to sell the at least one lead property.

According to an aspect of the present disclosure, the method further includes preventing, by the prediction module, a lead property having a high propensity to be assigned to an output list of property addresses of more than one third-party to reduce chance of less-welcomed cold calls/contacts by the property agents to vendors.

According to another aspect of the present disclosure, the method further includes connecting, by a data sharing module, with a third-party device associated with the at least one third-party to send the output list of property addresses.

Further, the method includes, collecting, by a feedback module, a feedback about a quality of the output list of property addresses from the at least one third-party device.

In some embodiments, the method also includes improving, by a learning module, a performance of the property lead finder system based on the feedback.

Another embodiment of the present disclosure provides a property lead finder system for determining a property lead. The property lead finder system includes a transceiving module configured clickstream data from at least one data source, wherein the clickstream data comprising property data, wealth properties history available within the at least one data source and user interaction data based on an interaction of a plurality of users with the at least one data source. The property lead finder system also includes a data processing module configured to: determine one or more potential target properties in a particular location from the property data by filtering out one or more properties from the plurality of properties; and generate a plurality of features for each of the one or more potential target properties. The lead finder system also includes a prediction module configured to calculate a future propensity for each of the one or more potential target properties based on the plurality of features. Based on the calculated future propensity for each of the one or more potential target properties, the prediction module may determine one or more property leads that may be up for sale in an upcoming predefined time.

According to an aspect of the present disclosure, the at least one data source comprises a real-estate website, and an online data analytics server comprising information associated with the real-estate website. In some embodiments, real-estate website may be an online portal to help property owners to sell or rent their properties. The real-estate websites may also allow the property owner to upload pictures, and other details about the property and charge a fee for the service. Many of these real-estate websites are managed by property management companies (which, in turn, may also employ property agents).

According to another embodiment of the present disclosure, the property data may include an historical property table comprising information about the plurality of properties, with the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

According to another embodiment of the present disclosure, the data processing module may determine one or more potential target properties in the particular location by filtering out the one or more properties comprising at least one of a property without any associated user interaction within the real-estate website, a property which was live for sale or rent at a time of user interaction, and a property with confirmed sold status in the past predefined time.

According to another embodiment of the present disclosure, the data processing module may be further configured to generate the plurality of features for each of the one or more potential target properties based on a property, location and transactions of a potential target property, an interaction of a plurality of users with the potential target property, and an interaction of the plurality of users with the real-estate website.

According to another embodiment of the present disclosure, the prediction module may calculate the future propensity for each of the one or more potential target properties by: training a classification by an eXtreme Gradient Boosting classification algorithm with adjustable parameters according to the property data; and predicting the future propensity via a well-trained XGBoost classification algorithm.

According to another embodiment of the present disclosure, the prediction module determines the one or more lead properties based on properties with the top 10% propensities in each state, which also have increased propensities over the last 3 months, properties with appraisal request within the last 3 months, and without sale activity in the last year, properties with sale dashboard request within the last 3 months, and without sale activity in the last year, and removing one or more properties for which the owner was recently contacted by a property agent, based on a feedback.

According to another aspect of the present disclosure, the prediction module is further configured to: is further configured to map the received clickstream data to a propensity to sell one or more lead properties at a level of a physical property address. Further, the prediction module may determine a propensity data comprising a property address of the one or more lead properties and a score indicating the propensity to sell the one or more lead properties based on the mapping, the propensity data comprises only properties with high propensity to sell. In some embodiments, the prediction module may match the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property.

In some embodiments, the prediction module may prevent a lead property having a high propensity to be assigned to an output list of property addresses of more than one third-party.

According to another embodiment of the present disclosure, the system also includes a data sharing module configured to connect with a third-party device associated with the at least one third party device to send at least one of the output list of property addresses and data about the one or more lead properties.

According to another embodiment of the present disclosure, the system also includes a feedback module configured to collect a feedback about a quality of the output list of property addresses from the at least one third-party device.

According to another embodiment of the present disclosure, the system also includes a learning module configured to improve the performance of the property lead finder system based on the feedback.

Another embodiment of the present disclosure provides a property lead finder system for determining a property lead including a transceiving module configured to receive property data of a plurality of properties from at least one data source. The system also includes a data processing module configured to: determine one or more potential target properties in a particular location from the property data by filtering out one or more properties from the plurality of properties; and generate a plurality of features for each of the one or more potential target properties. The prediction module is also configured to: calculate a future propensity for each of the one or more potential target properties based on the plurality of features; and, based on the calculated future propensity for each of the one or more potential target properties, determine one or more property leads that may be up for sale in an upcoming predefined time. The system further includes a data sharing module configured to connect with one or more third-party devices to send and receive data about the one or more property leads. The system also includes a feedback module configured to collect feedback from the one or more third-party devices associated with one or more third parties comprising property agents. Further, the system also includes a learning module configured to improve performance of the property lead finder system based on the feedback.

A yet another embodiment of the present disclosure provides a method for determining a property lead by using a property lead finder system. The method includes: receiving, by a transceiving module, clickstream data from at least one data source, wherein the clickstream data comprising property data, wealth properties history available within the at least one data source and user interaction data based on an interaction of a plurality of users with the at least one data source. The method also includes determining, by a data processing module, one or more potential target properties in a particular location from the property data by filtering out one or more properties from the plurality of properties. The method further includes generating, by the data processing module, a plurality of features for each of the one or more potential target properties; calculating, by a prediction module, a future propensity for each of the one or more potential target properties based on the plurality of features. The method and determining, by the prediction module, one or more property leads that may be up for sale in an upcoming predefined time based on the calculated future propensity for each of the one or more potential target properties.

According to an aspect of the present disclosure, the at least one data source comprises a real-estate website, and an online data analytics server comprising information associated with the real-estate website. Further, the property data may include an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

According to another aspect of the present disclosure, the one or more properties comprises at least one of: a property without any associated user interaction within the real-estate website; a property which was live for sale or rent at a time of user interaction; and a property with confirmed sold status in the past predefined time.

According to an aspect of the present disclosure, the method may also include generating, by the data processing module, the plurality of features for each of the one or more potential target properties based on a property, location and transactions of a potential target property, an interaction of a plurality of users with the potential target property, and an interaction of the plurality of users with the real-estate website.

According to an aspect of the present disclosure, the method further includes: mapping, by the prediction module, the received clickstream data to a propensity to sell one or more lead properties at a level of a physical property address; determining, by the prediction module, a propensity data comprising a property address of the one or more lead properties and a score indicating the propensity to sell the one or more lead properties based on the mapping, the propensity data comprises only properties with high propensity to sell; matching, by the prediction module, the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property; and preventing, by the prediction module, a lead property having a high propensity to be assigned to an output list of property addressed of more than one third-party.

According to another aspect of the present disclosure, the method may also include calculating, by the prediction module, the future propensity for each of the one or more potential target properties by: training a classification by an eXtreme Gradient Boosting classification algorithm with adjustable parameters according to the property data; and predicting the future propensity via a well-trained XGBoost classification algorithm.

According to another aspect of the present disclosure, the method may also include determining, by the prediction module, the one or more lead properties based on: properties with the top 10% propensities at each state, which also have increased propensities over the last 3 months; properties with appraisal request within the last 3 months, and without sale activity in the last year; properties with sale dashboard request within the last 3 months, and without sale activity in the last year; and removing one or more properties which the owner is recently contacted by a property agent, based on a feedback.

According to another aspect of the present disclosure, the method may also include connecting, by a data sharing module, with a third-party device associated with the at least one third party device to send at least one of the output list of property addresses and data about the one or more lead properties.

According to yet another aspect of the present disclosure, the method may also include: collecting, by a feedback module, a feedback about a quality of the output list of property addresses from the at least one third-party device; and improving, by a learning module, the performance of the property lead finder system based on the feedback.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment, where various embodiments of the present disclosure may function;

FIG. 1B is a schematic diagram illustrating another exemplary environment, where various embodiments of the present disclosure may function;

FIG. 2A is a block diagram illustrating various system elements of an exemplary property lead finder system, in accordance with an embodiment of the present disclosure;

FIG. 2B is a block diagram illustrating various system elements of another exemplary property lead finder system, in accordance with another embodiment of the present disclosure;

FIGS. 3A-3B is a flowchart diagram illustrating a method for determining a lead property by using the exemplary property lead finder system of FIG. 2A, in accordance with an embodiment of the present disclosure;

FIGS. 4A-4B is a flowchart diagram illustrating a method for improving a performance of the exemplary property lead finder system of FIG. 2B, in accordance with an embodiment of the present disclosure; and

FIG. 5 illustrates a flow diagram showing flow of information in the lead finder system of the FIG. 2B, in accordance with an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable code of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

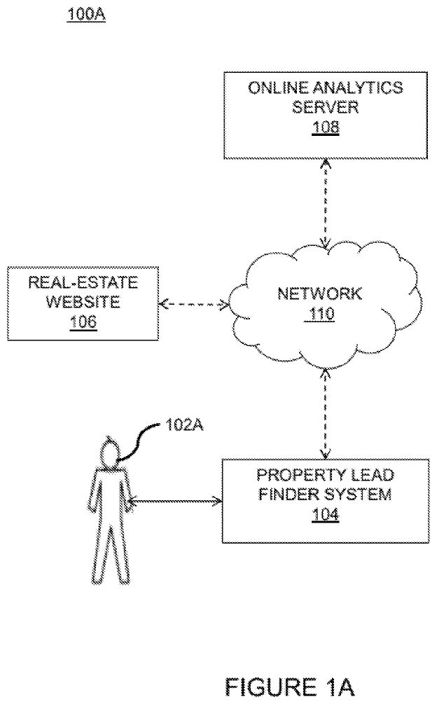

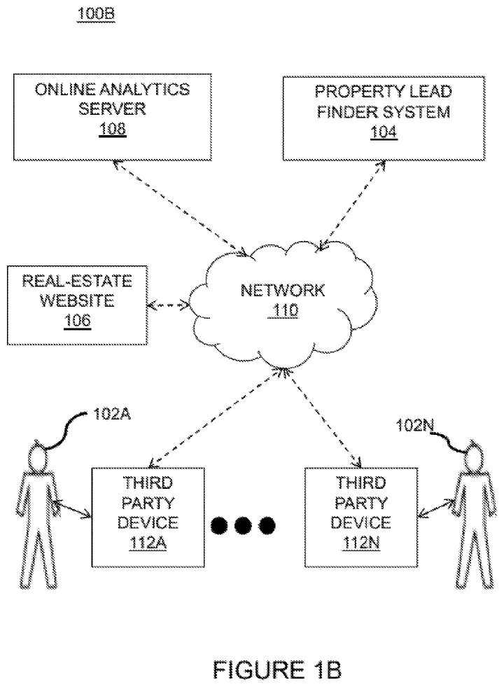

FIG. 1A is a schematic diagram illustrating an exemplary environment 100A, where various embodiments of the present disclosure may function. As shown, the environment 100A includes a user 102A who can access a property lead finder system 104 via a network 110 such as, but not limited to, the internet. In some embodiments, the user 102A may access the property lead finder system 104 via an application installed on a computing device. In alternative embodiments, the user 102A may access the property lead finder system 104 (hereinafter may be referred as system 104) by entering a network address such as a uniform resource locator (URL) in a web browser on the computing device. Examples of the computing device may include, but are not limited to, a computer, a smart phone, a smart watch, a smart television, a tablet computer, and a laptop computer. In the embodiments, the user 102A may be a property agent and/or a real-estate managing company dealing with renting, selling or buying of one or more real-estate properties like homes, offices, commercial dwellings etc. In other embodiments, the user 102A may be a website.

The property lead finder system 104 may be configured to receive (or send) clickstream data from at least one data source. The clickstream data may include the property data of a plurality of properties, wealth properties history available within the at least one data source and user interaction data based on an interaction of a plurality of users with the at least one data source. The at least one data source may be a real-estate website 106 such as, but not limited to, Domain website, and may be an online analytics server 108 that may be configured to store and provide information associated with the real-estate website 106 to the system 104. In some embodiments, the property data may include, but is not limited to, an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website 106, a transaction history data including all rent and sale activities over time for each of the plurality of properties. In some embodiments, the real-estate website 106 may be an online portal to help property owners to sell or rent their properties. The real-estate website 106 may also allow the property owners to upload pictures, and other details about the property and charge a fee for the service. The real-estate website 106 may be managed by a property management company(which, in turn, may also employ one or more property agents).

The system 104 may determine one or more potential target properties in a particular location from at least one of the clickstream data or the property data by filtering out one or more properties from the plurality of properties. The one or more properties that may be filtered out may include, but is not limited to, a property without any associate user interaction within the real-estate website, a property which was live for sale or rent at a time of user interaction, and a property with confirmed sold status in the past predefined time such as, in past 2 years.

Further, the system 104 may generate a plurality of features for each of the one or more potential target properties. The system 104 may generate the plurality of features for each of the one or more potential target properties based on a property, location and transactions of a potential target property, an interaction of a plurality of users with the potential target property, and an interaction of the plurality of users with the real-estate website.

The system 104 may also calculate a future propensity for each of the one or more potential target properties based on the plurality of features. In some embodiments, the system 104 may calculate the future propensity for each of the one or more potential target properties by: training a classification by an eXtreme Gradient Boosting classification algorithm with adjustable parameters according to the property data; and predicting the future propensity via a well-trained XGBoost classification algorithm.

Based on the calculated future propensity for each of the one or more potential target properties, the system 104 may determine one or more property leads that may be up for sale in an upcoming predefined time, such as, for example, in the coming six months. The property leads may include one or more properties whose property owner may want to sell or rent the properties in near future such as, but not limited to, in the next 1 year. In an exemplary scenario, the system 104 may determine the one or more property leads based on: properties with the top a predefined propensities, such as, but not limited to, 10% propensities, at each state, which also have increased propensities over the last 3 months; properties with appraisal request within the last predefined time period such as, but not limited to, 3 months, and without sale activity in the last year; properties with sale dashboard request within the last predefined time (e.g. 3 months), and without sale activity in the last year; and removing one or more properties which the owner is recently contacted by a property agent, based on a feedback.

FIG. 1B is a schematic diagram illustrating another exemplary environment 100B, where various embodiments of the present disclosure may function. In some embodiments, the system 104 may connect with one or more third-party devices 112A-112N (or systems) associated with one or more third parties (like the users 102A-102N) to send and/or receive data about the one or more lead properties. The non-limiting examples of the one or more third parties may include property agents, real-estate managing companies, users 102A-102N, and the like. The non-limiting examples of the one or more third-party devices (or systems) 112A-112N may include CRM systems/devices or storage devices of the property agent or real-estate management companies.

In some embodiments, the system 104 may be configured to collect feedback from the one or more third-party devices 112A-112N and/or the third parties like the users 102A-102N. The system 104 may be configured to improve performance of the system 104 based on the feedback.

In some embodiments, the system 104 may be configured to receive clickstream data from at least one data source. The clickstream data may include the property data, wealth properties history available within the at least one data source and user interaction data based on an interaction of a plurality of users with the at least one data source. The system 104 is configured to map the received clickstream data to a propensity to sell one or more lead properties at a level of a physical property address. Further, the system 104 may determine a propensity data comprising a property address of the one or more lead properties and a score indicating the propensity to sell the one or more lead properties based on the mapping. The system 104 match the propensity data against a third-party database, e.g. CRM system of a property agent or company, to determine at least one lead property for creating an output list of property addresses for at least one third-party. The output list of property addresses may include property information of at least one lead property that is common in the one or more lead properties and the third-party's database and a flag indicating the propensity to sell the at least one lead property. In some embodiments, the output list may include more information about the properties. In some embodiments, the propensity data comprises only properties with high propensity to sell. Further, the system 104 may prevent a lead property having a high propensity to be assigned to an output list of property addresses of more than one third-party i.e. more than one property agents.

The system 104 may then connect with a third-party device such as the third-party device 112A associated with the at least one third-party and send the output list of property addresses to the third-party device 112A. The system 104 may collect a feedback about a quality of the output list of property addresses from the at least one third-party device 112A. The performance of the property lead finder system 104 may be automatically improved based on the feedback

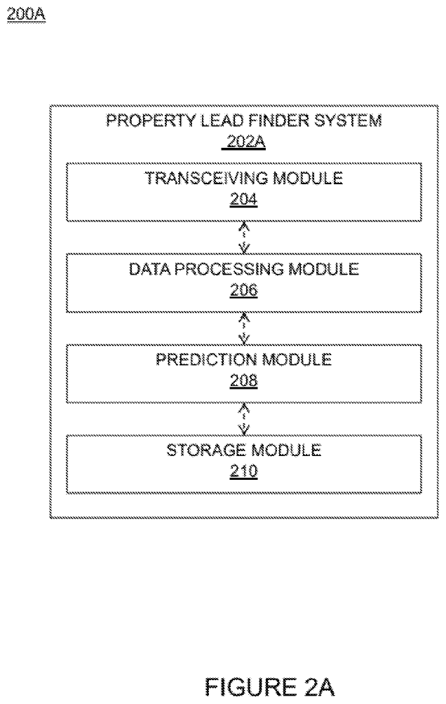

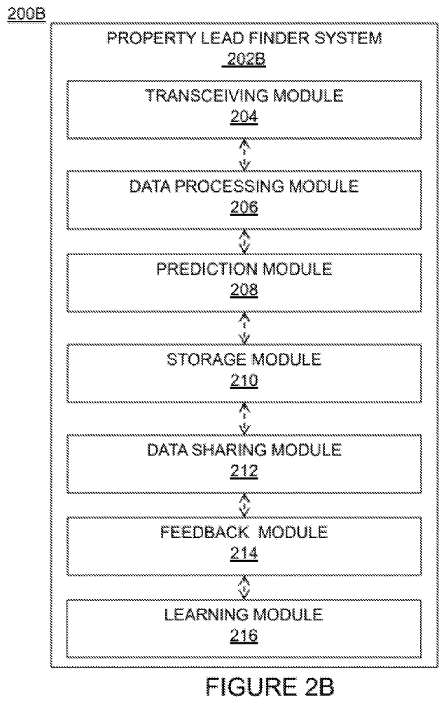

FIG. 2A is a block diagram 200A illustrating various system elements of an exemplary property lead finder system 202A, in accordance with an embodiment of the present disclosure. As shown, the property lead finder system 202A (hereinafter may be referred as system 202A) includes a transceiving module 204, a data processing module 206, a prediction module 208, and a storage module 210. As discussed with reference to FIG. 1A, the user 102A may access the system 202A through a computing device such as the smartphone.

The transceiving module 204 is configured to receive property data of a plurality of properties from at least one data source. In some embodiments, the transceiving module 204 is configured to receive clickstream data from at least one data source. The clickstream data may include the property data of a plurality of properties, wealth properties history available within the at least one data source and user interaction data based on an interaction of a plurality of users with the at least one data source. The at least one data source may be the real-estate website 106 such as, but not limited to, Domain website, and may be an online analytics server 108 that may be configured to store and provide information associated with the real-estate website 106 to the system 104. In some embodiments, the property data may include, but is not limited to, historical property table comprising information about the plurality of properties, the information for each of the plurality of properties comprising a property identifier (ID), a number of bedrooms in the property, a number of bathrooms, a number of parking spaces, an area of the property, location related information comprising state, city, region, postcode, suburb, and street, user interaction data within the real-estate website, a transaction history data comprising all rent and sale activities over time for each of the plurality of properties.

The data processing module 206 is configured to determine one or more potential target properties in a particular location from at least one of the clickstream data and the property data by filtering out one or more properties from the plurality of properties. In some embodiments, the data processing module 206 may determine one or more potential target properties in the particular location by filtering out the one or more properties comprising at least one of: a property without any associate user interaction within the real-estate website; a property which was live for sale or rent at a time of user interaction; and a property with confirmed sold status in the past predefined time. In some embodiments, the module 206 may tag all content comprising the property data using a word2vec model that is then used to infer the intentions of the user. Further, the data processing module 206 may convert unstructured data (i. e. natural language text) into structured data and then may determines what types of news articles people (or the user) are interested in reading. This may reveal intentions of the people or the user behavior.

The data processing module 206 is also configured to generate a plurality of features for each of the one or more potential target properties. In some embodiments, the data processing module 206 may generate the plurality of features for each of the one or more potential target properties based on a property, location and transactions of a potential target property, an interaction of a plurality of users with the potential target property, and an interaction of the plurality of users with the real-estate website.

The features generated for property, location and transactions of a potential target property may include, but are not limited to, features related to the property, related to the property's address, and related to transactions and neighboring properties. The non-limiting examples of the features related to the property may include bedrooms, bathrooms, parking spaces, area size, HAS_VALUATION (0/1 indicating availability of valuation for the property), months from last sale, listing sale, listing rent, months from last live rent or sale, last live rent or sale, and a status of the last sale transaction. The non-limiting examples of the features related to the property's address may include state, postcode, suburb, and region. The non-limiting examples of the features related to the transactions and neighboring properties may include number of properties, number of live properties sale or rent, ratio of live properties for sale or rent, comparing the number of live properties (sale/rent) within last 6 months to number of live properties (sale/rent) within same period last year, comparing the median price of properties sold within a past time such as, but not limited to, the last 6 months to median price of properties sold within same period last year, number of properties with repeated sales, and average days between these repeated sales.

In some embodiments, the data processing module 206 may generate features related to the interaction of the users with the target property and other properties from a Property Profile page (HPG), Sell Dashboard and Claim my Home page on the real-estate website. These features may include, but are not limited to, number of visitors, number of visits, duration from first visit, frequency of visit, landing method, number of other properties viewed by the user at different geographic levels; and these features may be categorised according to country, state, region, postcode, suburb and street. The user may be a person checking properties on the real-estate website(s). In some embodiments, the data processing module 206 may create different auxiliary features based on these features by attention to the ratio of each of them to the average value at state, region, postcode, suburb and street level.

In some embodiments, the data processing module 206 may map a set of users to a target property, and generate features for an interaction of the plurality of users with the real-estate website by collecting information about their interaction within the real-estate website. In some embodiments, the module 206 may use information of the user, and any other information the module 206 has collected about the user, for generating the features. Examples of the such features may include, but are not limited to, number of visited listings (sale/rent), content (e.g. articles, news), auction results, agent enquiries, searches, emails and calls, loan queries, appraisal requests, domain insurance, suburb profiles, street profiles, school profiles, domain connection services, inspections activities, shortlisted properties, and/or alerts. In some embodiments, the data processing module 206 may create different auxiliary features based on these features by attention to the ratio of each of them to the average value at state, region, postcode, suburb and street level.

In some embodiments, the prediction module 208 is configured to map the received clickstream data to a propensity to sell one or more lead properties at a level of a physical property address. Further, the prediction module 208 may determine a propensity data comprising a property address of the one or more lead properties and a score indicating the propensity to sell the one or more lead properties based on the mapping. In some embodiments, the propensity data comprises only properties with high propensity to sell. Furthermore, the prediction module 208 may match the propensity data against a third-party database (such as, an agent's CRM) to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property. Further, the prediction module 208 may prevent a lead property having a high propensity to be assigned to an output list of property addresses of more than one third-party.

The prediction module 208 is configured to calculate a future propensity for each of the one or more potential target properties based on the plurality of features. In some embodiments, the prediction module calculates the future propensity for each of the one or more potential target properties by: training a classification by eXtreme Gradient Boosting classification algorithm with adjustable parameters according to the property data; and predicting the future propensity via a well-trained XGBoost classification algorithm.

The XGBoost model has different parameters that may need to be adjusted, wherein the prediction module 208 may determine a couple of parameters based on property data from the real-estate website, and a set of parameters are tuned based on the data. Since the problem is unbalanced, to control the balance of positive and negative weights, the prediction module 208 may use a scale_pos_weight parameter. Based on the property data, a fixed value of 2*sum(negative cases)/sum(positive cases) may be used in the model. Further, the following parameters are adjusted automatically: maximum depth of each Tree, learning rate, maximum number of Trees, gamma; specifies the minimum loss reduction required to make a split, min_child_weight; defines the minimum sum of weights of all observations required in a child, subsample; denotes the fraction of observations to be randomly samples for each tree, colsample_bytree; denotes the fraction of columns to be randomly samples for each tree.

In some embodiments, to select the best parameters, the prediction module 208 may use a sliding window cross validation approach, wherein, for example, the first slide takes one year of data from Jan. 5, 2017 to Jan. 5, 2018 to construct the features, then the label of the first slide is created based on the listing in the six months starting from May 15, 2018 to Nov. 15, 2018, and then this slide creates the first training set. The features of the corresponding test set are created by considering the data from Jan. 6, 2018 to Jan. 12, 2018 and label of the test set is created by listing data from Dec. 15, 2018 to Jun. 15, 2019. The other training sets and test sets may also be created by shifting the first set by one month.

Based on the calculated future propensity for each of the one or more potential target properties, the prediction module 208 may determine one or more property leads that may be up for sale in an upcoming predefined time, such as, for example, in the coming two months. In some embodiments, the user 102A may define the predefined time and the prediction module 208 may determine one or more property leads accordingly. In some embodiments, the prediction module 208 may determine the one or more lead properties based on: properties with the top 10% propensities at each state, which also have increased propensities over the last 3 months; properties with appraisal request within the last 3 months, and without sale activity in the last year; properties with sale dashboard request within the last 3 months, and without sale activity in the last year; and by removing one or more properties for which the owner was recently contacted by a property agent, based on a feedback.

FIG. 2B is a block diagram 200B illustrating various system elements of another exemplary property lead finder system 202B, in accordance with another embodiment of the present disclosure. As shown, the property lead finder system 202B (hereinafter may be referred as system 202B) includes the transceiving module 204, the data processing module 206, the prediction module 208, and the storage module 210. Additionally, the system 202B includes a data sharing module 212, a feedback module 214, and a learning module 216. The prediction module 208 may generate the predictions after a regular interval such as, but not limited to, monthly, weekly, bi-weekly, and so forth.

Further, predictions i.e. the property leads, produced by the prediction module 208 get recorded in the storage module 210 and become immediately available for consumption by other users or the system 202A. A non-limiting example of the storage module 210 may include SnowFlake Database environment. Each month's prediction is correctly labelled and contains, among other information, the propensity score for each address to hit the market. The storage module 210 may use any of the existing database technologies or any future developed database technologies for storing the data. When the predictions are ready to be consumed, this is the appropriate time to start matching agencies' (i.e. third parties') CRM data with the output of the system 202. The high-level diagram below illustrates this process:

The data sharing module 212 may provide the interactive way for third parties to connect with an Agent Portal of a real-estate website or of the system 202A, and export their data to the real-estate website or to the system 202. In some embodiments, data sharing module 210 is configured to connect with a third-party device associated with the at least one third-party to send the output list of property addresses. The data sharing module 212 is configured to connect with one or more third-party devices (i.e. CRM as shown above) to send and receive data about the one or more lead properties. The lead finder App is the property lead finder system 202A of the present disclosure. The data sharing module 212 may export data from the CRM in a particular format and the data may include OwnershipID (source ID from CRM), contactID, PropertyID, first name, last name, email, mobile, unit number, street number, street name, suburb, postcode, state, date created (date property or contact was first created), last modified (date property or contact was last modified), source examples of the source may include, but are not limited to, an open home inspection, a real-estate searching website, and any other website and so forth, category (e.g. buyer, seller, renter, investor), agent name (details of the agent to assign to an agent in CRM), Agent email ID, agent phone, an agent ID, and so forth.

Once the data is correctly received by the data sharing module 212, then a job is started and the following steps are taken: ingestion of client CRM data into staging tables; standardization of address details data; washing (cleaning the data) against internal property data of the real-estate website to assign unique website specific property ID; and matching the assigned unique website specific property ID into the latest lead finder prediction i.e. the property leads.

In some embodiments, the data sharing module 212 may implement business rules to make sure a property is not served or shared with more than a predefined number of clients in a certain period of time. The predefined number may one or two clients.

For the matched properties that have been flagged by the system 202A, some extra columns may be added to the end of the input file i.e. the data received from the CRM. The non-limiting examples of the extra fields may include: a file_ID (internal system controller ID used for future reference and feedback checks); propensity_score (the actual likelihood for the property to come to the market); quality (this may be a number between 1 to 5 that specifies the quality of the lead produced, 1 being the lowest quality and 5 the highest quality); and website_property_ID (the website_property_ID may be used for feedback loop).

The feedback module 214 is configured to collect a feedback from the one or more third-party devices associated with one or more third parties comprising property agents regularly, and this may be after a fixed time interval such as monthly, weekly, and so forth. The examples of the feedback may include, but are not limited to: Listing Appointment Booked; Property Appraisal Requested; Future Seller <6 Months; Future Seller <12 Months; Future Seller 12+ Months; Number Disconnected; Does not own Property; Asked to be removed from Database; No Interest in Selling; and Already listed with another agent. In some embodiments, the feedback module 214 is configured to collect a feedback about a quality of the output list of property addresses from the at least one third-party device such as device 112A of FIG. 1B.

The feedbacks of the one or more third parties may be used for improving the performance by cause analysing of false-positive feedbacks, and improving the lead assignment to agents. The learning module 216 is configured to improve performance of the property lead finder system based on the feedback. Based on the feedback of agents from the same geographical location, the learning module 216 can determine which agent has more chances to convert a lead for a specific property.

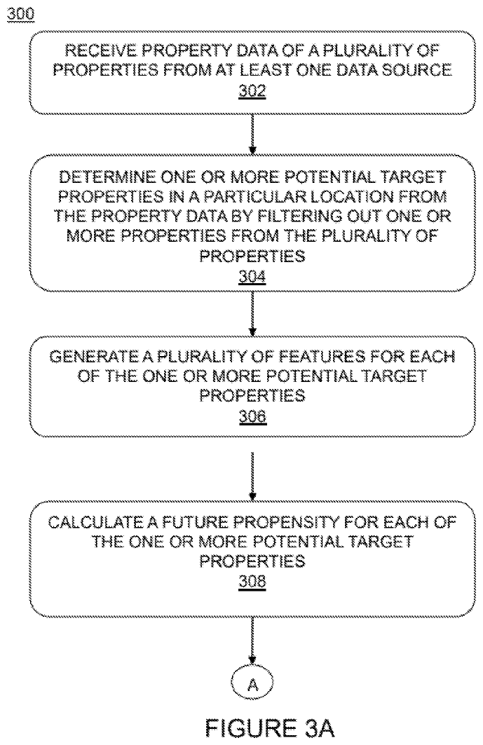

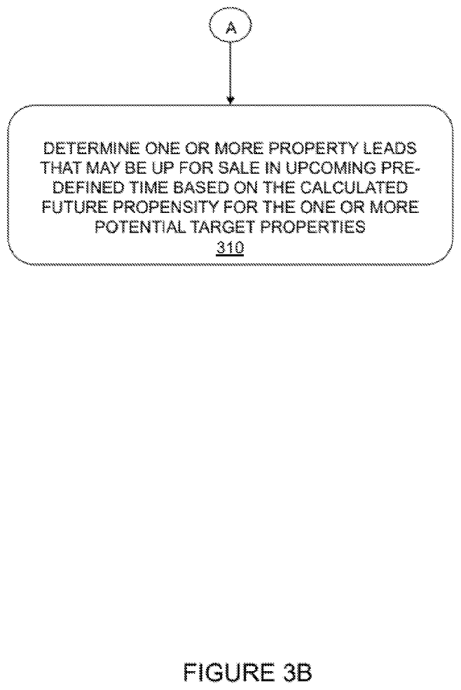

FIGS. 3A-3B is a flowchart diagram illustrating a method 300 for determining a lead property by using the exemplary property lead finder system 202A of FIG. 2A, in accordance with an embodiment of the present disclosure. The property lead finder system 202A includes the transceiving module 204, the data processing module 206, the prediction module 208, and the storage module 210.

At step 302, the system 202A receives property data of a plurality of properties from at least one data source. In some embodiments, the transceiving module 204 receives the property data. The at least one data source may include the real-estate website 106, and the online data analytics server 108 comprising information associated with the real-estate website 106. The property data may include an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

At step 304, the system 202A determines one or more potential target properties in a particular location from the property data by filtering out one or more properties from the plurality of properties. In some embodiments, the data processing module 206 determines the one or more potential target properties in the particular location from the property data by filtering out the one or more properties from the plurality of properties. The one or more properties may include, but are not limited to, at least one of a property without any associated user interaction within the real-estate website, a property which was live for sale or rent at a time of user interaction, and a property with confirmed sold status in the past predefined time.

At step 306, the system 202A generates a plurality of features for each of the one or more potential target properties. In some embodiments, the data processing module 206 generates the plurality of features for each of the one or more potential target properties based on a property, location and transactions of a potential target property, an interaction of a plurality of users with the potential target property, and an interaction of the plurality of users with the real-estate website.

Following this, at step 308, the system 202A calculates a future propensity for each of the one or more potential target properties based on the plurality of features. In some embodiments, the prediction module 208 calculates a future propensity for each of the one or more potential target properties based on the plurality of features by: training a classification by an eXtreme Gradient Boosting classification algorithm with adjustable parameters according to the property data; and predicting the future propensity via a well-trained XGBoost classification algorithm.

At step 310, the system 202A determines one or more property leads that may be up for sale in an upcoming predefined time based on the calculated future propensity for each of the one or more potential target properties. In some embodiments, the prediction module 208 determines the one or more property leads that may be up for sale in an upcoming predefined time based on: properties with the top propensities such as, top 10% propensities at each state, which also have increased propensities over the last predefined time period such as, 3 months; properties with appraisal request within the last 3 months, and without sale activity in the last year; properties with sale dashboard request within the last 3 months, and without sale activity in the last year; and removing one or more properties which the owner is recently contacted by a property agent, based on a feedback.

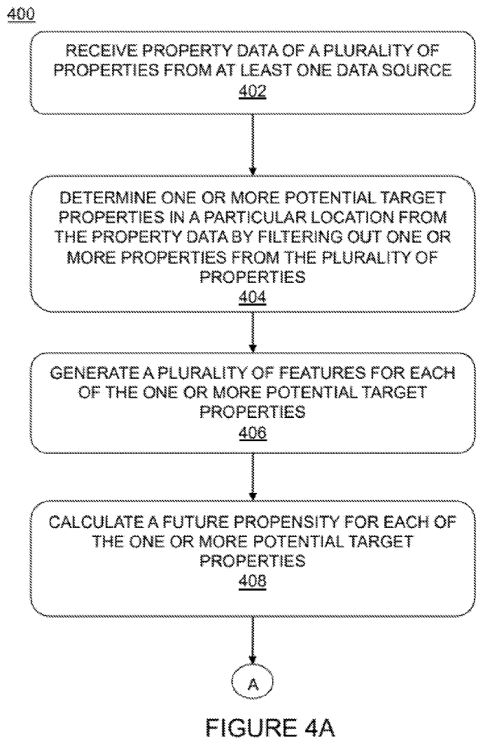

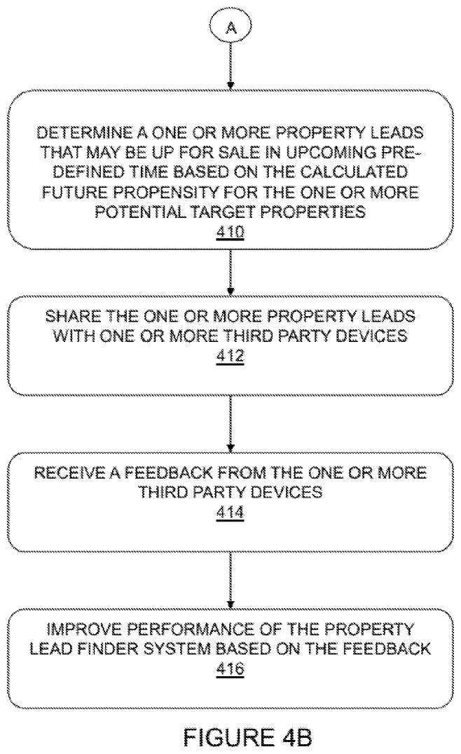

FIGS. 4A-4B is a flowchart diagram illustrating a method for improving the performance of an exemplary property lead finder system 202B of FIG. 2B, in accordance with an embodiment of the present disclosure. The property lead finder system 202B includes the transceiving module 204, the data processing module 206, the prediction module 208, the storage module 210, the data sharing module 212, the feedback module 214, and the learning module 216.

At step 402, the system 202B receives property data of a plurality of properties from at least one data source. In some embodiments, the transceiving module 204 receives the property data. The at least one data source may include the real-estate website 106, and the online data analytics server 108 comprising information associated with the real-estate website 106. The property data may include an historical property table comprising information about the plurality of properties, wherein the information for each of the plurality of properties comprises a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

At step 404, the system 202B determines one or more potential target properties in a particular location from the property data by filtering out one or more properties from the plurality of properties. In some embodiments, the data processing module 206 determines the one or more potential target properties in the particular location from the property data by filtering out the one or more properties from the plurality of properties. The one or more properties may include, but are not limited to, at least one of a property without any associated user interaction within the real-estate website, a property which was live for sale or rent at a time of user interaction, and a property with confirmed sold status in the past predefined time.

At step 406, the system 202B generates a plurality of features for each of the one or more potential target properties. In some embodiments, the data processing module 206 generates the plurality of features for each of the one or more potential target properties based on: a property, location and transactions of a potential target property; an interaction of a plurality of users with the potential target property; and an interaction of the plurality of users with the real-estate website.

At step 408, the system 202B calculates a future propensity for each of the one or more potential target properties based on the plurality of features. In some embodiments, the prediction module 208 calculates a future propensity for each of the one or more potential target properties based on the plurality of features by: training a classification by an eXtreme Gradient Boosting classification algorithm with adjustable parameters according to the property data; and predicting the future propensity via a well-trained XGBoost classification algorithm.

Following, at step 410, the system 202B determines one or more property leads that may be up for sale in an upcoming predefined time based on the calculated future propensity for each of the one or more potential target properties. In some embodiments, the prediction module 208 determines the one or more property leads that may be up for sale in an upcoming predefined time based on such as, but not limited to, properties with the top 10% propensities at each state, which also have increased propensities over the last 3 months; properties with appraisal request within the last 3 months, and without sale activity in the last year; properties with sale dashboard request within the last 3 months, and without sale activity in the last year; and by removing one or more properties for which the owner was recently contacted by a property agent, based on a feedback.

At step 412, the system 202B shares the one or more property leads with one or more third-party devices, such as, for example, a CRM system or device of the user 102A. In some embodiments, the data sharing module 212 shares the one or more property leads with the one or more third-party devices 112A-112N associated with one or more third parties such as the users 102A-102N.

At step 414, the system 202B collects a feedback from the one or more third-party devices and/or the third parties. In some embodiments, the feedback module 214 collects the feedback.

Thereafter at step 416, the system 202B improves its own performance based on the feedback. In some embodiments, the learning module 216 may rely on machine learning and artificial intelligence (AI) to improve the performance of the system 202B based on the feedback collected from the third-party devices 112A-112N and/or the third parties. The feedback may include how accurate the one or more lead properties are and so forth.

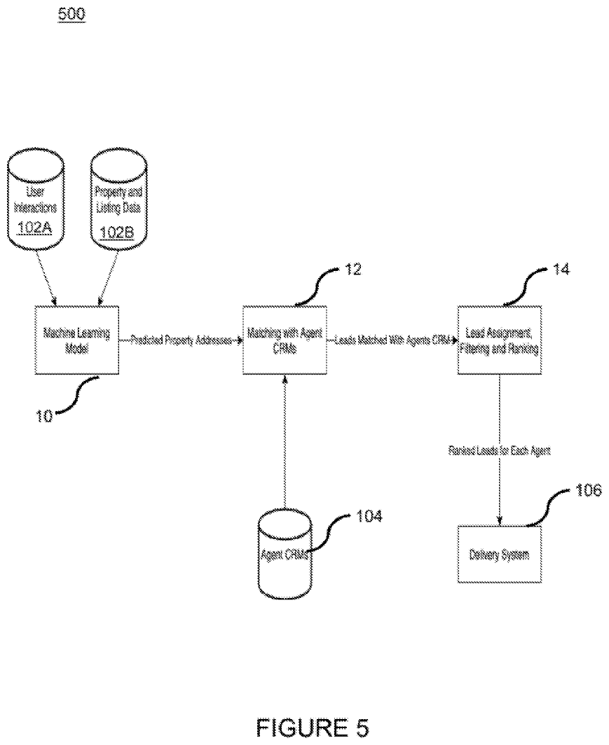

FIG. 5 illustrates a flow diagram 500 showing flow of information in the lead finder system 202 of FIG. 2B, in accordance with an embodiment of the present disclosure. The transceiving module 204 of the lead finder system 202 is configured to receive clickstream data from at least one data source. The clickstream data may include such as, but not limited to, user intentions data 102A and property and listing data 102B. The prediction module 208 of the system 202 may use machine learning model at step 10 to predict property addresses. Then at step 12, the prediction module 208 may match the predicted property addresses of leads with agent's CRMs 104. Thereafter, at step 14, the prediction module 208 may rank leads for each agent. Further, the prediction module 208 may prevent a lead property having a high propensity to be assigned to an output list of property addresses of more than one third-party. The delivery system (or the data sharing module 212) may share the output list including filtered and ranked leads with the agent(s).

The present disclosure provides a property lead finder system for predicting a lead property that may be available for sale or rent in the near future.

The present disclosure provides a property lead finder system for predicting when a property might be up for sale in the near future. The system may assist users, such as property agents, in identifying a lead property that may be available for sale (or rent) in the near future or at a particular time. This allows property agents to have advanced knowledge of a selling or renting interest of a property owner associated with a lead property and accordingly, the property agent may contact the property owner to engage the property owner to facilitate the selling or renting process and provide other information and guidance.

The present disclosure provides a property lead finder system for predicting when a property owner of an associated property may want to sell or rent an associated property.

The disclosed lead finder system may provide a machine learning solution that considers a variety of elements in a collaborative initiative with multiple stakeholders to strengthen the relationships, boost revenues and enhance the agencies' resource allocation by minimizing unnecessary approaches in a property listing journey.

Further, the lead finder system is configured to preserve data privacy of the users and customers. The lead finder system will never share any sort of direct user information with the property agents or companies. The output of the lead finder system or method is only an ordering of properties that are in an agent's CRM combined with a flag indicating the propensity to sell. Further, the lead finder system incorporates a machine learning model that is a sophisticated black box AI solution working on data aggregated at the level of a property rather than any individual user. By considering all the property data and user interaction together, the lead finder system prevents the model from making the decision from few activities of just one user.

The system by matching the flagged properties against agencies' client-directory, may analyse the strength of relationship of the agents with each of their contacts to ultimately provide every one of flagged properties to its best-possible agency in the area. Further, this process may use the established trust to shorten the nurturing timespan for agencies and also reduce the less-welcomed cold calls and contacts to the vendors.

The disclosed lead finder system can help real estate agents to find their next customer more efficiently. The system designed to leverage a real-estate website's data capabilities, agent's CRM and advanced machine learning techniques to increase the efficiency of this process. The final output of the system is a list of predicted addresses matched with the best agency. Getting from non-physical signals to a physical output; in this case from user interactions to addresses, would be the main differences of the proposed system in comparison with other user behaviors applications which deliver users identities derived by human interactions. This goal is achieved by the following structure. A system administers the power to spot prospective properties by leveraging clickstream data across a real-estate platform (i.e., iOS, Android and web). In addition to the user behaviors, the wealth of properties' history available within the real-estate website plays a significant role in fine-tuning the results. The system maps this information to propensity to sell at the level of a physical property address. The user information and property data are excluded from the result and the output of the prediction step for each Australian property is the property address and a score indicating the propensity to sell. Properties with low propensity to sell are excluded further from the list. The result of prediction (property address and score) is matched against an agent's CRM. As a result, the system creates a list of property addresses from the agent's CRM that are also in the output of the prediction step. Thereafter, the system may order the list by the prediction scores. This process gets executed for all the agents that have shared their CRM with us, subject to the business logic layer described below. Thereafter, the system may apply business logic layer to create a final output (or output list of property addresses) for each Agent. The system may prevent a high propensity address to be assigned to the output list of more than one agent, reduces the chance of less-welcomed cold calls/contacts by the agents to the vendors and applies business logics of the product reflecting the relationship among the real-estate website (or platforms), agencies and potential vendors. For instance, by matching the flagged properties against agencies' client-directory, the system analyses the strength of relationship of the agents with each of their contacts to ultimately provide every one of flagged properties to its best-possible agency in the area. In fact, this process would use the established trust to shorten the nurturing timespan for agencies and also reduce the less-welcomed cold calls and contacts to the vendors.

The present disclosure provides a property lead finder system configured to predict a future decision of a property owner about selling or renting an associated property. The property lead finder system may be an artificial intelligence (AI) based system that predicts the future decision of the property owner based on a wide range of signals, data points, and behavioral patterns. The property lead finder system may include a collection of fairly complex processes, data modelling methods, filtering and activation channels that may work together to predict the future decision of the property owner. The property lead finder system may use three main data sources comprising: 1) an historical property table including a monthly (or weekly, or bi-weekly) snapshot of a property table from a real-estate website, wherein the property table may include information such as property ID, number of bedrooms, number of bathrooms, number of parking spaces, area, and information related to a location such as state, region, postcode, suburb, and street of a plurality of properties; 2) user interaction within the real-estate website derived from a web platform providing analytics like, for example, Google Analytics; and 3) a transaction history table containing all the rent and sale activities for each property over time.

In some embodiments, the property lead finder system may also filter out one or more properties from the plurality of properties to predict a lead property that may be up for sale in near future. The system may filter out the one or more properties, such as, for example: properties without any associate user interaction within the real-estate website; properties which were live for sale and rent at the time of the user interaction; and properties that have been confirmed sold in a past predefined time, such as, for example, in past six months, one year, or two years.

Further, the property lead finder system may include a feature generation device configured to create features at the following three levels: property, location and transaction level; interaction of users at the property level; and interaction of users at the real-estate website level.

It will be understood that the devices and the databases referred to in the previous sections are not necessarily utilized together in the methods or systems of the embodiments. Rather, these devices are merely exemplary of the various devices that may be implemented within a computing device or the server device. They can be implemented in another exemplary device, and other devices as appropriate, and can communicate via a network to the exemplary server device.

It will be appreciated that several of the above-disclosed features and functions, and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those in the art are capable of choosing suitable manufacturing and design details.

The terminology used herein is for the purpose of describing particular embodiments only and is not intended to be limiting of the disclosure. It will be appreciated that several of the above disclosed features and functions, and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A property lead finder system for determining a property lead, comprising:
a transceiving module configured to receive clickstream data from at least one data source, wherein the clickstream data comprising property data, wealth properties history available within the at least one data source and user interaction data based on an interaction of a plurality of users with the at least one data source;
a prediction module configured to:
map the received clickstream data to a propensity to sell one or more lead properties at a level of a physical property address;
determine a propensity data comprising a property address of the one or more lead properties and a score indicating the propensity to sell the one or more lead properties based on the mapping; and
match the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property.

2. The property lead finder system of claim 1, wherein:
the at least one data source comprises a real-estate website, and an online data analytics server comprising information associated with the real-estate website;
the property data comprises an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties; and
the propensity data comprises only properties with high propensity to sell.

3. The property lead finder system of claim 2, wherein the prediction module is further configured to prevent a lead property having a high propensity to be assigned to an output list of property addresses of more than one third-party.

4. The property lead finder system of claim 1 further comprising:
a data sharing module configured to connect with a third-party device associated with the at least one third-party to send the output list of property addresses;
a feedback module configured to collect a feedback about a quality of the output list of property addresses from the at least one third-party device; and
a learning module configured to improve a performance of the property lead finder system based on the feedback.

5. A method for determining a lead property by using a property lead finder system, comprising:
receiving, by a transceiving module, clickstream data from at least one data source, wherein the clickstream data comprising property data, wealth properties history available within the at least one data source and user interaction data based on an interaction of a plurality of users with the at least one data source;
mapping, by a prediction module, the received clickstream data to a propensity to sell one or more lead properties at a level of a physical property address;
determining, by the prediction module, a propensity data comprising a property address of the one or more lead properties and a score indicating the propensity to sell the one or more lead properties based on the mapping; and
matching, by the prediction module, the propensity data against a third-party database to determine at least one lea property for creating an output list of property addresses for at least one third-party, wherein the output list of property addresses comprises property information of at least one lead property that is common in the one or more lead properties and the third-party's database and a flag indicating the propensity to sell the at least one lead property.

6. The method of claim 5, wherein:
the at least one data source comprises a real-estate website, and an online data analytics server comprising information associated with the real-estate website;
the property data comprises an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties; and
the propensity data comprises only properties with high propensity to sell.

7. The method of claim 6 further comprising, preventing, by the prediction module, a lead property having a high propensity to be assigned to an output list of property addresses of more than one third-party.

8. The method of claim 5 further comprising:
connecting, by a data sharing module, with a third-party device associated with the at least one third-party to send the output list of property addresses;
collecting, by a feedback module, a feedback about a quality of the output list of property addresses from the at least one third-party device; and
improving, by a learning module, a performance of the property lead finder system based on the feedback.

9. A property lead finder system for determining a property lead, comprising:
a transceiving module configured clickstream data from at least one data source, wherein the clickstream data comprising property data, wealth properties history available within the at least one data source and user interaction data based on an interaction of a plurality of users with the at least one data source;
a data processing module configured to:
determine one or more potential target properties in a particular location from the property data by filtering out one or more properties from the plurality of properties; and
generate a plurality of features for each of the one or more potential target properties; and
a prediction module configured to:
calculate a future propensity for each of the one or more potential target properties based on the plurality of features; and
based on the calculated future propensity for each of the one or more potential target properties, determine one or more property leads that may be up for sale in an upcoming predefined time.

10. The property lead finder system of claim 9, wherein:
the at least one data source comprises a real-estate website, and an online data analytics server comprising information associated with the real-estate website; and
the property data comprises an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

11. The property lead finder system of claim 10, wherein the data processing module determines one or more potential target properties in the particular location by filtering out the one or more properties comprising at least one of: a property without any associated user interaction within the real-estate website; a property which was live for sale or rent at a time of user interaction; and a property with a confirmed sold status in the past predefined time.

12. The property lead finder system of claim 11, wherein the data processing module is configured to generate the plurality of features for each of the one or more potential target properties based on a property, location and transactions of a potential target property, an interaction of a plurality of users with the potential target property, and an interaction of the plurality of users with the real-estate website.

13. The property lead finder system of claim 11, wherein the prediction module calculates the future propensity for each of the one or more potential target properties by:
training a classification by an eXtreme Gradient Boosting classification algorithm with adjustable parameters according to the property data; and
predicting the future propensity via a well-trained XGBoost classification algorithm.

14. The property lead finder system of claim 13, wherein the prediction module is further configured to:
map the received clickstream data to a propensity to sell one or more lead properties at a level of a physical property address;
determine a propensity data comprising a property address of the one or more lead properties and a score indicating the propensity to sell the one or more lead properties based on the mapping, the propensity data comprises only properties with high propensity to sell;
match the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property; and
prevent a lead property having a high propensity to be assigned to an output list of property addresses of more than one third-party.

15. The property lead finder system of claim 14 further comprising:
a data sharing module configured to connect with a third-party device associated with the at least one third party device to send at least one of the output list of property addresses and data about the one or more lead properties;
a feedback module configured to collect a feedback about a quality of the output list of property addresses from the at least one third-party device; and
a learning module configured to improve performance of the property lead finder system based on the feedback.

16. A method for determining a property lead by using a property lead finder system, comprising:
receiving, by a transceiving module, clickstream data from at least one data source, wherein the clickstream data comprising property data, wealth properties history available within the at least one data source and user interaction data based on an interaction of a plurality of users with the at least one data source;
determining, by a data processing module, one or more potential target properties in a particular location from the property data by filtering out one or more properties from the plurality of properties;
generating, by the data processing module, a plurality of features for each of the one or more potential target properties;
calculating, by a prediction module, a future propensity for each of the one or more potential target properties based on the plurality of features; and
determining, by the prediction module, one or more property leads that may be up for sale in an upcoming predefined time based on the calculated future propensity for each of the one or more potential target properties.

17. The method of claim 16, wherein:
the at least one data source comprises a real-estate website, and an online data analytics server comprising information associated with the real-estate website; and
the property data comprises an historical property table comprising information about the plurality of properties, the information for each of the plurality of properties comprising a property identifier (ID), a number of bedrooms in the property, a number of bathrooms, a number of parking spaces, an area, location related information comprising state, city, region, postcode, suburb, and street, user interaction data within the real-estate website, and/or a transaction history data comprising all rent and sale activities over time for each of the plurality of properties.

18. The method of claim 17, wherein the one or more properties comprises at least one of a property without any associated user interaction within the real-estate website, a property which was live for sale or rent at a time of user interaction, and a property with a confirmed sold status in the past predefined time.

19. The method of claim 18 further comprising generating, by the data processing module, the plurality of features for each of the one or more potential target properties based on a property, location and transactions of a potential target property, an interaction of a plurality of users with the potential target property, and an interaction of the plurality of users with the real-estate website.

20. The method of claim 19 further comprising calculating, by the prediction module, the future propensity for each of the one or more potential target properties by:
training a classification by an eXtreme Gradient Boosting classification algorithm with adjustable parameters according to the property data; and
predicting the future propensity via a well-trained XGBoost classification algorithm.

21. The method of claim 20 further comprising:
mapping, by the prediction module, the received clickstream data to a propensity to sell one or more lead properties at a level of a physical property address;
determining, by the prediction module, a propensity data comprising a property address of the one or more lead properties and a score indicating the propensity to sell the one or more lead properties based on the mapping, the propensity data comprises only properties with high propensity to sell;
matching, by the prediction module, the propensity data against a third-party database to determine at least one lead property for creating an output list of property addresses for at least one third-party, wherein the output list of property addresses comprises property information of at least one lead property that is common in the one or more lead properties and the third-party's database and a flag indicating the propensity to sell the at least one lead property; and
preventing, by the prediction module, a lead property having a high propensity to be assigned to an output list of property addressed of more than one third-party.

22. The method of claim 21 further comprising:
connecting, by a data sharing module, with a third-party device associated with the at least one third party device to send at least one of the output list of property addresses and data about the one or more lead properties;
collecting, by a feedback module, a feedback about a quality of the output list of property addresses from the at least one third-party device; and
improving, by a learning module, the performance of the property lead finder system based on the feedback.
